(19) United States
(12) Patent Application Publication
(10) Pub. No.: US 2021/0095165 A1
(43) Pub. Date: Apr. 1, 2021

(54) Impact-Resistant Stretch-Release Adhesives

(71) Applicant: 3M INNOVATIVE PROPERTIES COMPANY, St. Paul, MN (US)

(72) Inventors: Ross J. DeVolder, Woodbury, MN (US); Ramasubramani Kuduva Raman Thanumoorthy, Woodbury, MN (US); Michele A. Craton, Cottage Grove, MN (US); Rongzhi Huang, Woodbury, MN (US); Sung-Tso Lin, Taoyuan City (TW)

(21) Appl. No.: 15/733,215

(22) PCT Filed: Dec. 3, 2018
(86) PCT No.: PCT/IB2018/059575

§ 371 Date: Jun. 11, 2020

Related U.S. Application Data
(60) Provisional application No. 62/597,124, filed on Dec. 11, 2017.

(51) Int. Cl. C09J 7/30; C09J 153/02; C09J 133/08

(52) U.S. Cl. CPC C09J 7/30; C09J 153/02; C09J 133/08; C08F 220/06; C09J 2301/308; C09J 2453/00; C09J 2433/00; C09J 2301/416

(57) ABSTRACT

Stretch-release adhesives are provided which are derived from mixtures comprising: a) a tackified styrenic block copolymer comprising: i) one or more tackifiers; and ii) one or more styrenic block copolymers; wherein the weight ratio of i) to ii) is not more than 1.0:2.0; and b) one or more (meth)acrylate polymers. In some embodiments, the weight ratio of a) to b) is between 0.4:1.0 and 5.0:1.0 and in some between 1.0:1.0 and 3.9:1.0. In some embodiments, the one or more styrenic block copolymers comprise at least 90 wt % linear block copolymers. In some embodiments, the tackifiers are miscible with rubbery blocks of the styrenic block copolymers and not miscible with the (meth)acrylate polymers. In some embodiments, the mixture is crosslinked. Tapes comprising stretch-release adhesives according to the present disclosure are also provided.

### FIELD OF THE DISCLOSURE

This disclosure relates to stretch-release adhesives, including embodiments that demonstrate high impact resistance and may thus be used in applications subject to extreme motion and/or physical shock.

### BACKGROUND OF THE DISCLOSURE

The following references may be relevant to the general field of technology of the present disclosure: U.S. Pat. Nos. 6,887,919; 8,721,832; 6,680,096; 6,544,639; 9,624,404; US 2015/315421; US 2008/280086; U.S. Pat. No. 6,001,471; WO 2009/114683; WO 2014/127341; and WO 2017/066517.

### SUMMARY OF THE DISCLOSURE

Briefly, the present disclosure provides stretch-release adhesives derived from mixtures comprising: a) a tackified styrenic block copolymer comprising: i) one or more tackifiers; and ii) one or more styrenic block copolymers; wherein the weight ratio of i) to ii) is not more than 1.0:2.0; and b) one or more (meth)acrylate polymers. In some embodiments, the weight ratio of i) to ii) is not more than 1.0:4.0 and at least 1.0:10.0. In some embodiments, the weight ratio of a) to b) is between 0.4:1.0 and 5.0:1.0; and in some embodiments at least 1.0:1.0 and not more than 3.9:1.0. In some embodiments, the tackified styrenic block copolymer is not tacky. In some embodiments, the one or more styrenic block copolymers comprise less than 18 wt % styrenic content. In some embodiments, the one or more styrenic block copolymers comprise at least 90 wt % linear block copolymers. In some embodiments, the one or more styrenic block copolymers comprise at least 55 wt % styrenic block copolymers comprising a rubbery block comprising unsaturated bonds. In some embodiments, the one or more tackifiers have solubility parameters of less than 9.0 (cal/cm²)^{1/2}, in some less than 8.9 (cal/cm²)^{1/2}, in some less than 8.8 (cal/cm²)^{1/2}, and in some less than 8.7 (cal/cm²)^{1/2}. In some embodiments, the one or more styrenic block copolymers comprise styrenic blocks and rubbery blocks and the one or more tackifiers are miscible with the rubbery blocks. In some embodiments, the one or more tackifiers are not miscible with the one or more (meth)acrylate polymers. In some embodiments, the one or more tackifiers are alicyclic saturated hydrocarbon resins. In some embodiments, the one or more (meth)acrylate polymers include at least 1 wt % highly polar monomeric units. In some embodiments, the one or more (meth)acrylate polymers include not more than 15 wt % highly polar monomeric units. In some embodiments, the one or more (meth)acrylate polymers have solubility parameters of greater than 9.0 (cal/cm²)^{1/2}, in some greater than 9.1 (cal/cm²)^{1/2}, in some greater than 9.2 (cal/cm²)^{1/2}, and in some greater than 9.3 (cal/cm²)^{1/2}. In some embodiments, the mixture is crosslinked. In some embodiments, the mixture is crosslinked by e-beam radiation. In some embodiments, the mixture is crosslinked by UV radiation. In some embodiments, the mixture is crosslinked by incorporation of aromatic end-block tackifiers. Additional embodiments of stretch-release adhesives according to the present disclosure are described below under “Selected Embodiments.”

In another aspect, the present disclosure provides tapes comprising stretch-release adhesives according to the present disclosure. In some embodiments, the tapes are monolayers of the present stretch-release adhesives, while in other embodiments the tapes are multilayer tapes comprising at least one layer of the stretch-release adhesives according to the present disclosure. Additional embodiments of the tapes of the present disclosure are described below under “Selected Embodiments.”

The preceding summary of the present disclosure is not intended to describe each embodiment of the present invention. The details of one or more embodiments of the invention are also set forth in the description below. Other features, objects, and advantages of the invention will be apparent from the description and from the claims.

In this application:

“monomeric unit” means units of a polymer derived from particular monomers;

“highly polar monomeric units” means units of a polymer derived from monomers having highly polar functional moieties such as carboxylic acids, sulfonic acids, phosphoric acids, alcohols, lactams, lactones; substituted amides, substituted amines, carbamates, and the like;

“(meth)acrylate monomers” include acrylate monomers and/or methacrylate monomers;

“(meth)acrylate polymers” includes polymers that include units derived from acrylate monomers, polymers that include units derived from methacrylate monomers, and polymers that include both units derived from acrylate monomers and units derived from methacrylate monomers;

“tack” and “tacky” refer to the ability of a material to adhere to a solid surface when brought into contact with light pressure such as hand pressure at room temperature; and

“substituted” means, for a chemical species, group or moiety, substituted by conventional substituents which do not interfere with the desired product or process, e.g., substituents can be alkyl, alkoxy, aryl, phenyl, halo (F, Cl, Br, I), cyano, nitro, etc.

All scientific and technical terms used herein have meanings commonly used in the art unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### DETAILED DESCRIPTION

The present disclosure provides stretch-release adhesives derived from mixtures comprising: a) a tackified styrenic block copolymer comprising: i) one or more tackifiers and ii) one or more styrenic block copolymers; wherein the weight ratio of i) to ii) is not more than 1.0:2.0; and b) one or more (meth)acrylate polymers. The tackified styrenic block copolymer component contains only a low level of tackifier, generally less than would be necessary to provide an effective pressure sensitive adhesive, and typically much less than would be necessary to provide a pressure sensitive adhesive. In some embodiments, the mixture is crosslinked to form the stretch-release adhesive.

Stretch-release adhesives are typically pressure sensitive adhesives. In general, a pressure sensitive adhesive is a material that has the characteristics of a) aggressive and permanent tack at room temperature; b) ability to firmly adhere to a variety of dissimilar surfaces upon contact without the need of more than finger or hand pressure; c) requires no activation by water, solvent, or heat in order to exert a strong adhesive holding force toward materials, typically including paper, plastic, glass, wood, cement, and metal; and in some but not all cases: d) has sufficient cohesive holding power and elastic nature that it can be removed from smooth surfaces without leaving a residue. In some embodiments, pressure sensitive adhesives are polymeric materials having have a room temperature compression modulus measured at 1 Hz of less than 1×10⁵ dynes/cm² or in some embodiments less than 3×10⁶ dynes/cm². Materials having high modulus are typically non-tacky. Stretch-release adhesives additionally possess the characteristics that they lose adhesion when stretched, and they have sufficient cohesion that they can be stretched to the point of releasing their adherend without breaking, i.e., without cohesive failure. The ability of a particular material to exhibit stretch-release performance may be contingent on the nature of the surface to which the adhesive is bound.

Typical embodiments of stretch-release adhesives according to the present disclosure demonstrate the additional property of high impact resistance. As a result, such stretch-release adhesives according to the present disclosure may be used in applications subject to extreme motion and/or physical shock.

Any suitable (meth)acrylate polymers may be used in the practice of the present disclosure. In some embodiments, the (meth)acrylate polymers are pressure sensitive adhesives in themselves. In some embodiments, suitable (meth)acrylate polymers are acrylate polymers. In some embodiments, the (meth)acrylate polymers include highly polar monomeric units. In some embodiments, the highly polar monomeric units are derived from one or more of hydroxyethyl acrylate, hydroxypropyl acrylate, hydroxyethyl methacrylate, hydroxypropyl methacrylate, N-methylolacrylamide, acrylic acid, methacrylic acid, allyl alcohol, maleic anhydride, itaconic anhydride, and itaconic acid. In some embodiments, the (meth)acrylate polymers include monomeric units derived from (meth)acrylic esters having linear, cyclic or branched alkyl groups. Specific examples of such compounds include, but are not limited to, ethyl acrylate, n-butyl acrylate, n-pentyl acrylate, n-hexyl acrylate, n-heptyl acrylate, n-octyl acrylate, n-nonyl acrylate, 2-ethylhexyl acrylate, isooctyl acrylate, n-lauryl acrylate, stearyl acrylate, isobornyl acrylate, isobornyl methacrylate, norbornyl acrylate. In some embodiments, suitable (meth)acrylate polymers are grafted with additional polymeric material. In some embodiments, suitable (meth)acrylate polymers are not grafted with additional polymeric material. In some embodiments, suitable (meth)acrylate polymers are branched. In some embodiments, suitable (meth)acrylate polymers are not branched. In some embodiments, suitable (meth)acrylate polymers comprise not more than 40 weight percent of monomer units derived from monomers other than (meth)acrylate monomers, in some not more than 30 weight percent, in some not more than 20 weight percent, in some not more than 10 weight percent, in some not more than 5 weight percent, in some embodiments not more than 1 weight percent, and in some embodiments no monomer units derived from monomers other than (meth)acrylate monomers.

Any suitable styrenic block copolymers may be used in the practice of the present disclosure. Suitable styrenic block copolymers include styrenic blocks and rubbery blocks. Examplary styrenic block copolymers include SIS, SBS, SIBS, SEBS, SEPS and SEEPS copolymers. In some embodiments, styrenic block copolymers that include unsaturated bonds in the rubbery block are preferred. Styrenic blocks of styrenic block copolymers comprise monomer units derived from monovinyl aromatic monomers. Exemplary monovinyl aromatic monomers include styrene, vinylpyridine, vinyl toluene, alpha-methyl styrene, methyl styrene, dimethylstyrene, ethylstyrene, diethyl styrene, tbutylstyrene, di-n-butylstyrene, isopropylstyrene, other alkylated-styrenes, other substituted styrenes, styrene analogs, and styrene homologs. In some embodiments, the monovinyl aromatic monomer is selected from the group consisting of styrene, styrene-compatible monomers or monomer blends, and combinations thereof. Rubbery blocks of styrenic block copolymers comprise monomer units derived from polymerized conjugated diene, a hydrogenated derivative of a polymerized conjugated diene, an olefin, or combinations thereof. In some embodiments, the monomers comprise 4 to 12 carbon atoms. Exemplary conjugated dienes include butadiene, isoprene, ethylbutadiene, phenylbutadiene, piperylene, pentadiene, hexadiene, ethylhexadiene, and dimethylbutadiene. The polymerized conjugated dienes may be used individually or as copolymers with each other. In some embodiments, suitable styrenic block copolymers are linear. In some embodiments, suitable styrenic block copolymers are linear di- or triblock copolymers. In some embodiments of the present disclosure, the styrenic block copolymers include only limited amounts, or none, of branched block copolymers or star block copolymers. In some embodiments, the styrenic block copolymers include only limited amounts, or none, of block copolymers that include 1,2-diene monomer units.

Any suitable tackifiers may be used in the practice of the present disclosure. In some embodiments, tackifiers are selected from hydrogenated hydrocarbon tackifiers, such as alicyclic saturated hydrocarbon resins, fully hydrogenated C5 and C9 tackifiers, and combinations thereof. Of particular interest are fully hydrogenated C9 hydrogenated tackifiers. Examples of C9 hydrogenated and fully hydrogenated hydrocarbon tackifiers include those sold under the trade designation: “REGALITE S-5100”, “REGALITE R-7100”, “REGALITE R-9100”, “REGALITE R-1125”, “REGALITE S-7125”, “REGALITE S-1100”, “REGALITE R-1090”, “REGALREZ 6108”, “REGALREZ 1085”, “REGALREZ 1094”, “REGALREZ 1126”, “REGALREZ 1139”, and “REGALREZ 3103”, sold by Eastman Chemical Co., Middelburg, Netherlands; “PICCOTAC” and EASTOTAC” sold by Eastman Chemical Co.; “ARKON P-140”, “ARKON P-125”, “ARKON P-115”, “ARKON P-100”, “ARKON P-90”, “ARKON M-135”, “ARKON M-115”, “ARKON M-100”, and “ARKON M-90” sold by Arakawa Chemical Inc., Chicago, Ill.; and “ESCOREZ 5000 series” sold by Exxon Mobil Corp., Irving, Tex.

In some embodiments, the tackifiers are compatible with rubbery blocks of the styrenic block copolymer. A tackifier is “compatible” with a block if it is at least miscible with that block, although it may also be miscible with other blocks. For example, a tackifier that is compatible with a rubbery block will be miscible with the rubbery block, but may also be miscible with a glassy block. Generally, the miscibility of a tackifier with a block can be determined by measuring the effect of the tackifier on the Tg of that block. If a tackifier is miscible with a block it will alter (e.g., increase) the Tg of that block.

Solubility parameter is a well-known index for characterizing the polarity of a compound. Generally, tackifiers having relatively low solubility parameters will associate with rubbery blocks, and not with acrylic polymers having high solubility parameters, particularly acrylic polymers that incorporate highly polar monomers.

The tackified styrenic block copolymer according to the present disclosure contains a low level of tackifier, typically an amount inadequate to render the tackified styrenic block copolymer effectively tacky. In some embodiments, the tackified styrenic block copolymer is not itself a pressure sensitive adhesive, although the stretch-release adhesive is a pressure sensitive adhesive.

In some embodiments, the recited mixture is crosslinked in the stretch-release adhesive of the present disclosure. Crosslinks may be of any suitable form, including in some embodiments e-beam crosslinks, UV crosslinks, or crosslinks established by the incorporation of one or more aromatic end-block tackifiers (e.g., ENDEX, KRISTALEX, CUMAR, NOVARES). Crosslinks may be generated by any suitable process, including in some embodiments e-beam treatment, UV treatment, or addition of one or more aromatic end-block tackifiers (e.g., ENDEX, KRISTALEX, CUMAR, NOVARES).

In some embodiments, the stretch-release adhesive of the present disclosure is formed into a tape. In some embodiments, the tape is a monolayer of the stretch-release adhesive. In some embodiments, the tape is a multilayer tape comprising at least one layer of the stretch-release adhesive, typically being at least one outermost layer. In some embodiments, the tape is a multilayer tape comprising at least two layers of the stretch-release adhesive, typically being the two outermost layers of the tape. In some embodiments, the tape may also comprise one or more inner layers of the stretch-release adhesive.

In some embodiments, the recited mixture is compounded by hot melt methods. In some embodiments, the recited mixture is compounded with little or no solvent, in some embodiments less than 10 weight percent solvent based on the weight of the mixture, in some less than 5%, in some less than 2%, and in some less than 1%.

### Selected Embodiments

The following embodiments of the articles and methods according to the present disclosure, designated by letter and number, are intended to further illustrate the present disclosure but should not be construed to unduly limit this disclosure.

A1. A stretch-release adhesive derived from a mixture comprising:
a) a tackified styrenic block copolymer comprising:
   i) one or more tackifiers; and
   ii) one or more styrenic block copolymers;
   wherein the weight ratio of i) to ii) is not more than 1.0:2.0; and
b) one or more (meth)acrylate polymers.
   A2. The stretch-release adhesive according to embodiment A1 wherein the weight ratio of i) to ii) is not more than 1.0:3.0.
   A3. The stretch-release adhesive according to embodiment A1 wherein the weight ratio of i) to ii) is not more than 1.0:4.0.
   A4. The stretch-release adhesive according to embodiment A1 wherein the weight ratio of i) to ii) is not more than 1.0:5.0.
   A5. The stretch-release adhesive according to any of embodiments A1-A4 wherein the weight ratio of i) to ii) is at least 1.0:20.0.
   A6. The stretch-release adhesive according to any of embodiments A1-A4 wherein the weight ratio of i) to ii) is at least 1.0:15.0.
   A7. The stretch-release adhesive according to any of embodiments A1-A4 wherein the weight ratio of i) to ii) is at least 1.0:10.0.
   A8. The stretch-release adhesive according to any of the preceding embodiments wherein the tackified styrenic block copolymer is not tacky.
   A9. The stretch-release adhesive according to any of the preceding embodiments wherein the tackified styrenic block copolymer is not a pressure sensitive adhesive.
   A10. The stretch-release adhesive according to any of the preceding embodiments wherein the tackified styrenic block copolymer has a room temperature compression modulus measured at 1 Hz of greater than 5×10⁵ dynes/cm².
   A11. The stretch-release adhesive according to any of the preceding embodiments wherein the tackified styrenic block copolymer has a room temperature compression modulus measured at 1 Hz of greater than 1×10⁶ dynes/cm².
   A12. The stretch-release adhesive according to any of the preceding embodiments wherein the tackified styrenic block copolymer has a room temperature compression modulus measured at 1 Hz of greater than 5×10⁶ dynes/cm².
   A13. The stretch-release adhesive according to any of the preceding embodiments wherein the tackified styrenic block copolymer has a room temperature compression modulus measured at 1 Hz of greater than 1×10⁷ dynes/cm².
   A14. The stretch-release adhesive according to any of the preceding embodiments wherein the weight ratio of a) to b) is between 0.4:1.0 and 5.0:1.0.
   A15. The stretch-release adhesive according to any of the preceding embodiments wherein the weight ratio of a) to b) is at least 0.8:1.0.
   A16. The stretch-release adhesive according to any of the preceding embodiments wherein the weight ratio of a) to b) is at least 1.0:1.0.
   A17. The stretch-release adhesive according to any of the preceding embodiments wherein the weight ratio of a) to b) is at least 1.1:1.0.
   A18. The stretch-release adhesive according to any of the preceding embodiments wherein the weight ratio of a) to b) is at least 1.7:1.0.
   A19. The stretch-release adhesive according to any of the preceding embodiments wherein the weight ratio of a) to b) is not more than 4.2:1.0.
   A20. The stretch-release adhesive according to any of the preceding embodiments wherein the weight ratio of a) to b) is not more than 3.9:1.0.
   A21. The stretch-release adhesive according to any of the preceding embodiments wherein the weight ratio of a) to b) is not more than 3.6:1.0.
   AS1. The stretch-release adhesive according to any of the preceding embodiments wherein the one or more styrenic block copolymers comprise less than 18 wt % styrenic content.
   AS2. The stretch-release adhesive according to any of the preceding embodiments wherein the one or more styrenic block copolymers comprise less than 17 wt % styrenic content.
   AS3. The stretch-release adhesive according to any of the preceding embodiments wherein the one or more styrenic block copolymers comprise less than 16 wt % styrenic content.
   AS4. The stretch-release adhesive according to any of the preceding embodiments wherein the one or more styrenic block copolymers comprise less than 15 wt % star block copolymer.
   AS5. The stretch-release adhesive according to any of the preceding embodiments wherein the one or more styrenic block copolymers comprise less than 10 wt % star block copolymer
   AS6. The stretch-release adhesive according to any of the preceding embodiments wherein the one or more styrenic block copolymers comprise less than 5 wt % star block copolymer
   AS7. The stretch-release adhesive according to any of the preceding embodiments wherein the one or more styrenic block copolymers comprise less than 1 wt % star block copolymer
   AS8. The stretch-release adhesive according to any of the preceding embodiments wherein the one or more styrenic block copolymers comprise no star block copolymer.
   AS9. The stretch-release adhesive according to any of the preceding embodiments wherein the one or more styrenic block copolymers comprise less than 15 wt % 1,2-diene copolymer.
   AS10. The stretch-release adhesive according to any of the preceding embodiments wherein the one or more styrenic block copolymers comprise less than 10 wt % 1,2-diene copolymer.
   AS11. The stretch-release adhesive according to any of the preceding embodiments wherein the one or more styrenic block copolymers comprise less than 5 wt % 1,2-diene copolymer.
   AS12. The stretch-release adhesive according to any of the preceding embodiments wherein the one or more styrenic block copolymers comprise less than 1 wt % 1,2-diene copolymer.
   AS13. The stretch-release adhesive according to any of the preceding embodiments wherein the one or more styrenic block copolymers comprise no 1,2-diene copolymer.
   AS14. The stretch-release adhesive according to any of the preceding embodiments wherein the one or more styrenic block copolymers comprise at least 90 wt % linear block copolymers.
   AS15. The stretch-release adhesive according to any of the preceding embodiments wherein the one or more styrenic block copolymers comprise at least 95 wt % linear block copolymers.
   AS16. The stretch-release adhesive according to any of the preceding embodiments wherein the one or more styrenic block copolymers comprise at least 99 wt % linear block copolymers.
   AS17. The stretch-release adhesive according to any of the preceding embodiments wherein the one or more styrenic block copolymers comprise 100 wt % linear block copolymers.
   AS18. The stretch-release adhesive according to any of the preceding embodiments wherein the one or more styrenic block copolymers comprise at least 35 wt % triblock copolymers.
   AS19. The stretch-release adhesive according to any of the preceding embodiments wherein the one or more styrenic block copolymers comprise at least 45 wt % triblock copolymers.
   AS20. The stretch-release adhesive according to any of the preceding embodiments wherein the one or more styrenic block copolymers comprise at least 55 wt % triblock copolymers.
   AS21. The stretch-release adhesive according to any of the preceding embodiments wherein the one or more styrenic block copolymers comprise at least 65 wt % triblock copolymers.
   AS22. The stretch-release adhesive according to any of the preceding embodiments wherein the one or more styrenic block copolymers comprise at least 35 wt % styrenic block copolymers comprising a rubbery block comprising unsaturated bonds.
   AS23. The stretch-release adhesive according to any of the preceding embodiments wherein the one or more styrenic block copolymers comprise at least 55 wt % styrenic block copolymers comprising a rubbery block comprising unsaturated bonds.
   AS24. The stretch-release adhesive according to any of the preceding embodiments wherein the one or more styrenic block copolymers comprise at least 75 wt % styrenic block copolymers comprising a rubbery block comprising unsaturated bonds.
   AS25. The stretch-release adhesive according to any of the preceding embodiments wherein the one or more styrenic block copolymers comprise at least 95 wt % styrenic block copolymers comprising a rubbery block comprising unsaturated bonds.
   AS26. The stretch-release adhesive according to any of the preceding embodiments wherein the one or more styrenic block copolymers comprise at least 35 wt % combined weight of SIS triblock and SI diblock copolymers.
   AS27. The stretch-release adhesive according to any of the preceding embodiments wherein the one or more styrenic block copolymers comprise at least 55 wt % combined weight of SIS triblock and SI diblock copolymers.
   AS28. The stretch-release adhesive according to any of the preceding embodiments wherein the one or more styrenic block copolymers comprise at least 75 wt % combined weight of SIS triblock and SI diblock copolymers.
   AS29. The stretch-release adhesive according to any of the preceding embodiments wherein the one or more styrenic block copolymers comprise at least 95 wt % combined weight of SIS triblock and SI diblock copolymers.
   AT1. The stretch-release adhesive according to any of the preceding embodiments wherein the one or more tackifiers have solubility parameters of less than 9.0 (cal/cm²)^{1/2}.
   AT2. The stretch-release adhesive according to any of the preceding embodiments wherein the one or more tackifiers have solubility parameters of less than 8.9 (cal/cm²)^{1/2}.
   AT3. The stretch-release adhesive according to any of the preceding embodiments wherein the one or more tackifiers have solubility parameters of less than 8.8 (cal/cm²)^{1/2}.
   AT4. The stretch-release adhesive according to any of the preceding embodiments wherein the one or more tackifiers have solubility parameters of less than 8.7 (cal/cm²)^{1/2}.
   AT5. The stretch-release adhesive according to any of the preceding embodiments wherein the one or more styrenic block copolymers comprise styrenic blocks and rubbery blocks and the one or more tackifiers are miscible with the rubbery blocks.
   AT6. The stretch-release adhesive according to any of the preceding embodiments wherein the one or more styrenic block copolymers comprise styrenic blocks and rubbery blocks and the one or more tackifiers are compatible with the rubbery blocks.
   AT7. The stretch-release adhesive according to any of the preceding embodiments wherein the one or more styrenic block copolymers comprise styrenic blocks and rubbery blocks and the one or more tackifiers are not miscible with the styrenic blocks.
   AT8. The stretch-release adhesive according to any of the preceding embodiments wherein the one or more styrenic block copolymers comprise styrenic blocks and rubbery blocks and the one or more tackifiers are not compatible with the styrenic blocks.
   AT9. The stretch-release adhesive according to any of the preceding embodiments wherein the one or more tackifiers are not miscible with the one or more (meth)acrylate polymers.
   AT10. The stretch-release adhesive according to any of the preceding embodiments wherein the one or more tackifiers are not compatible with the one or more (meth)acrylate polymers.
   AT11. The stretch-release adhesive according to any of the preceding embodiments wherein the one or more tackifiers are alicyclic saturated hydrocarbon resins.
   AT12. The stretch-release adhesive according to any of the preceding embodiments wherein the one or more tackifiers are fully hydrogenated C9 tackifiers.
   AM1. The stretch-release adhesive according to any of the preceding embodiments wherein the one or more (meth)acrylate polymers include at least 1 wt % highly polar monomeric units.
   AM2. The stretch-release adhesive according to any of the preceding embodiments wherein the one or more (meth)acrylate polymers include at least 2 wt % highly polar monomeric units.
   AM3. The stretch-release adhesive according to any of the preceding embodiments wherein the one or more (meth)acrylate polymers include at least 3 wt % highly polar monomeric units.
   AM4. The stretch-release adhesive according to any of the preceding embodiments wherein the one or more (meth)acrylate polymers include at least 4 wt % highly polar monomeric units.
   AM5. The stretch-release adhesive according to any of the preceding embodiments wherein the one or more (meth)acrylate polymers include at least 5 wt % highly polar monomeric units.
   AM6. The stretch-release adhesive according to any of the preceding embodiments wherein the one or more (meth)acrylate polymers include at least 1 wt % acid-functional monomeric units.
   AM7. The stretch-release adhesive according to any of the preceding embodiments wherein the one or more (meth)acrylate polymers include at least 2 wt % acid-functional monomeric units.
   AM8. The stretch-release adhesive according to any of the preceding embodiments wherein the one or more (meth)acrylate polymers include at least 3 wt % acid-functional monomeric units.
   AM9. The stretch-release adhesive according to any of the preceding embodiments wherein the one or more (meth)acrylate polymers include at least 4 wt % acid-functional monomeric units.
   AM10. The stretch-release adhesive according to any of the preceding embodiments wherein the one or more (meth)acrylate polymers include at least 5 wt % acid-functional monomeric units.
   AM11. The stretch-release adhesive according to any of the preceding embodiments wherein the one or more (meth)acrylate polymers include at least 1 wt % acrylic acid monomeric units.
   AM12. The stretch-release adhesive according to any of the preceding embodiments wherein the one or more (meth)acrylate polymers include at least 2 wt % acrylic acid monomeric units.
   AM13. The stretch-release adhesive according to any of the preceding embodiments wherein the one or more (meth)acrylate polymers include at least 3 wt % acrylic acid monomeric units.
   AM14. The stretch-release adhesive according to any of the preceding embodiments wherein the one or more (meth)acrylate polymers include at least 4 wt % acrylic acid monomeric units.
   AM15. The stretch-release adhesive according to any of the preceding embodiments wherein the one or more (meth)acrylate polymers include at least 5 wt % acrylic acid monomeric units.
   AM16. The stretch-release adhesive according to any of the preceding embodiments wherein the one or more (meth)acrylate polymers include not more than 15 wt % highly polar monomeric units.
   AM17. The stretch-release adhesive according to any of the preceding embodiments wherein the one or more (meth)acrylate polymers include not more than 15 wt % acid-functional monomeric units.
   AM18. The stretch-release adhesive according to any of the preceding embodiments wherein the one or more (meth)acrylate polymers include not more than 15 wt % acrylic acid monomeric units.
   AM19. The stretch-release adhesive according to any of the preceding embodiments wherein the one or more (meth)acrylate polymers include not more than 12 wt % highly polar monomeric units.
   AM20. The stretch-release adhesive according to any of the preceding embodiments wherein the one or more (meth)acrylate polymers include not more than 12 wt % acid-functional monomeric units.
   AM21. The stretch-release adhesive according to any of the preceding embodiments wherein the one or more (meth)acrylate polymers include not more than 12 wt % acrylic acid monomeric units.
   AM22. The stretch-release adhesive according to any of the preceding embodiments wherein the one or more (meth)acrylate polymers include not more than 9 wt % highly polar monomeric units.
   AM23. The stretch-release adhesive according to any of the preceding embodiments wherein the one or more (meth)acrylate polymers include not more than 9 wt % acid-functional monomeric units.
   AM24. The stretch-release adhesive according to any of the preceding embodiments wherein the one or more (meth)acrylate polymers include not more than 9 wt % acrylic acid monomeric units.
   AM25. The stretch-release adhesive according to any of the preceding embodiments wherein the one or more (meth)acrylate polymers include not more than 7 wt % highly polar monomeric units.
   AM26. The stretch-release adhesive according to any of the preceding embodiments wherein the one or more (meth)acrylate polymers include not more than 7 wt % acid-functional monomeric units.
   AM27. The stretch-release adhesive according to any of the preceding embodiments wherein the one or more (meth)acrylate polymers include not more than 7 wt % acrylic acid monomeric units.
   AM28. The stretch-release adhesive according to any of the preceding embodiments wherein the one or more (meth)acrylate polymers have solubility parameters of greater than 9.0 (cal/cm²)^{1/2}.
   AM29. The stretch-release adhesive according to any of the preceding embodiments wherein the one or more (meth)acrylate polymers have solubility parameters of greater than 9.1 (cal/cm²)^{1/2}.
   AM30. The stretch-release adhesive according to any of the preceding embodiments wherein the one or more (meth)acrylate polymers have solubility parameters of greater than 9.2 (cal/cm²)^{1/2}.
   AM31. The stretch-release adhesive according to any of the preceding embodiments wherein the one or more (meth)acrylate polymers have solubility parameters of greater than 9.3 (cal/cm²)^{1/2}.
   AM32. The stretch-release adhesive according to any of the preceding embodiments wherein the one or more (meth)acrylate polymers have solubility parameters of greater than 9.4 (cal/cm²)^{1/2}.
   AM33. The stretch-release adhesive according to any of the preceding embodiments wherein the one or more (meth)acrylate polymers are tacky.
   AM34. The stretch-release adhesive according to any of the preceding embodiments wherein the one or more (meth)acrylate polymers are pressure sensitive adhesives.
   AM35. The stretch-release adhesive according to any of the preceding embodiments wherein the one or more (meth)acrylate polymers have a room temperature compression modulus measured at 1 Hz of less than 1×10⁷ dynes/cm².
   AM36. The stretch-release adhesive according to any of the preceding embodiments wherein the one or more (meth)acrylate polymers have a room temperature compression modulus measured at 1 Hz of less than 5×10⁶ dynes/cm².
   AM37. The stretch-release adhesive according to any of the preceding embodiments wherein the one or more (meth)acrylate polymers have a room temperature compression modulus measured at 1 Hz of less than 2×10⁶ dynes/cm².
   AM38. The stretch-release adhesive according to any of the preceding embodiments wherein the one or more (meth)acrylate polymers have a room temperature compression modulus measured at 1 Hz of less than 5×10⁵ dynes/cm².
   AD1. The stretch-release adhesive according to any of the preceding embodiments wherein the mixture is crosslinked.
   AD2. The stretch-release adhesive according to any of the preceding embodiments obtained by crosslinking the mixture.
   AD3. The stretch-release adhesive according to embodiment AD1 wherein the mixture is crosslinked by e-beam radiation.
   AD4. The stretch-release adhesive according to embodiment AD1 wherein the mixture is crosslinked by UV radiation.
   AD5. The stretch-release adhesive according to embodiment AD1 wherein the mixture is crosslinked by inclusion of aromatic end-block tackifiers.
   AD6. The stretch-release adhesive according to embodiment AD2 wherein crosslinking the mixture comprises application of e-beam radiation.
   AD7. The stretch-release adhesive according to embodiment AD2 wherein crosslinking the mixture comprises application of UV radiation.
   AD8. The stretch-release adhesive according to embodiment AD2 wherein crosslinking the mixture comprises incorporation of aromatic end-block tackifiers.
   AR1. The stretch-release adhesive according to any of the preceding embodiments which is a pressure sensitive adhesive and which can be stretched to the point of releasing an adherend without cohesive failure.
   AR2. The stretch-release adhesive according to any of the preceding embodiments which is a pressure sensitive adhesive and which can be bound to both of a first and second adherend and stretched to the point of releasing at least one of the first and second adherends without cohesive failure.
   AR3. The stretch-release adhesive according to embodiment AR2 wherein at least one of the first and second adherends is metal.
   AR4. The stretch-release adhesive according to embodiment AR2 wherein at least one of the first and second adherends is aluminum.
   AR5. The stretch-release adhesive according to embodiment AR2 wherein at least one of the first and second adherends is polymer.
   AR6. The stretch-release adhesive according to embodiment AR2 wherein at least one of the first and second adherends is polyamide.
   T1. A tape comprising the stretch-release adhesive according to any of the preceding embodiments.
   T2. The tape according to embodiment T1 which is a monolayer of the stretch-release adhesive.
   T3. The tape according to embodiment T1 which is a multilayer tape and which comprises at least one layer of the stretch-release adhesive.
   T4. The tape according to embodiment T3 which additionally comprises one or more layers of thermoplastic elastomer.
   T5. The tape according to embodiment T1 which is a three-layer tape comprising two surface layers of stretch-release adhesive and an internal layer of thermoplastic elastomer.
   T6. The tape according to embodiment T5 wherein the thickness of the two surface layers of stretch-release adhesive is 15-75% of the thickness of the internal layer of thermoplastic elastomer.
   T7. The tape according to embodiment T5 wherein the thickness of the two surface layers of stretch-release adhesive is 30-70% of the thickness of the internal layer of thermoplastic elastomer.
   T8. The tape according to any of embodiments T1-T7 having a thickness of 20-500 micrometers.
   T9. The tape according to any of embodiments T1-T7 having a thickness of 50-300 micrometers.
   T10. The tape according to any of embodiments T1-T7 having a thickness of 100-200 micrometers.
   T1. The tape according to any of embodiments T1-T10 comprised in a hand-held electronic device.
   M1. A method of joining two adherends comprising the steps of adhering a tape according to any of embodiments T1-T5 to a first adherend and joining the first adherend to a second adherend by contact of the tape with the second adherend.
   M2. The method according to embodiment M1 wherein at least one of the first and second adherends is metal.
   M3. The method according to embodiment M1 wherein at least one of the first and second adherends is aluminum.
   M4. The method according to any of embodiments M1-M3 wherein at least one of the first and second adherends is polymer.
   M5. The method according to any of embodiments M1-M3 wherein at least one of the first and second adherends is polyamide.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or from other commercial chemical suppliers or may be synthesized by known methods. All parts, percentages, ratios, etc. in the examples and the rest of the specification are by weight, unless noted otherwise. The following abbreviations are used: m=meters; cm=centimeters; mm=millimeters; μm=micrometers; ft=feet; in =inch; RPM=revolutions per minute; kg=kilograms; oz=ounces; lb=pounds; Pa=Pascals; sec=seconds; min=minutes; hr=hours; and RH=relative humidity. The terms “weight %”, “% by weight”, and “wt. %” are used interchangeably.

### Materials

| Material | Description |
|---|---|
| AA | Acrylic acid |
| EHA | 2-Ethylhexyl acrylate |
| IOA | Isooctyl acrylate |
| IOTG | Isooctyl thioglycolate |
| Irg1010 | Pentaerythritol tetrakis(3-(3,5-ditert-butyl-4-hydroxyphenyl)propionate), an |
| | antioxidant available under the trade designation IRGANOX 1010 available |
| | from BASF Corporation, Florham Park, NJ. |
| Irg651 | 2-Dimethoxy-2-phenylacetophenone, a photoinitiator available under the trade |
| | designation IRGACURE 651 from available from BASF Corporation, Florham |
| | Park, NJ. |
| F85 | A glycerol ester of highly hydrogenated refined wood rosin, available under the |
| | trade designation FORAL 85 from Pinova Corporation, Brunswick, GA. |
| P100 | A fully hydrogenated hydrocarbon resin, available under the trade designation |
| | ARKON P-100 from Arakawa Chemical, Chicago, IL. |
| P125 | A fully hydrogenated hydrocarbon resin, available under the trade designation |
| | ARKON P-125 from Arakawa Chemical, Chicago, IL. |
| Calsol | A naphthenic process oil (plasticizer), available under the trade designation |
| | CALSOL 5550 from Calumet, Indianapolis, IN. |
| K1161 | A styrene-isoprene-styrene triblock copolymer having an approximate styrene |
| | content of 15% and 19% diblock content, available under the trade designation |
| | KRATON D1161 P from Kraton Performance Polymers, Houston, TX. |
| Test Panel 1 | Acrylic sheets with abrasive resistant coating cut to the dimensions of 3 mm |
| | (0.118 inch) × 50.8 mm (2 inches) × 101.6 mm (4 inches), available under the |
| | trade designation ACRYLITE AR from Evonik Corporation, Parisippany, NJ. |
| Test Panel 2 | Anodized aluminum panel cut to the dimension of 50.8 mm (2 inches) by 127 |
| | mm (5 inches) |
| Test Panel 3 | Stainless steel panel cut to the dimension of 50.8 mm (2 inches) by 127 mm (5 |
| | inches), available from Cheminstruments, Fairfield, OH. |
| EL35H | A 88 micrometer thickness film comprising a layer of oriented NYLON, a |
| | layer of aluminum, and a layer of polypropylene, in that order, available under |
| | the trade designation D-EL35H(3) from Dai Nippon Printing Company, Tokyo, |
| | Japan. |
| Transfer | A 0.0035 inch (88.9 micrometers) thick acrylic adhesive transfer tape available |
| Tape 1 | under the trade designation 9453LE from 3M Company, St. Paul, MN. |
| Release | A 0.003 inch (75 micrometer) thick polyester release liner having a different |
| Liner 1 | release coating on each side to provide a differential release. |
| Commercial | A commercially available 0.15 mm thickness white double-sided bond and |
| Tape | detach tape, available under the trade designation TESA 70415, from Tesa, |
| | Norderstdt, Germany. |

### Test Methods

### Stretch Release Test

An EL35H film was bonded to Test Panel 3 using Transfer Tape 1, with the NYLON face of the EL35H film facing outward, forming a rigid film surface. Tape samples were cut into 12.7 mm (0.5 inch) wide strips having a bonding area of 887 mm², and were laminated to the NYLON face of the rigid EL35H film. A 4.5 kg roller was rolled over the laminated tape strips 4 times to ensure bonding to the EL35H film. Next, Release Liner 1 was removed from the tape sample and either Test Panel 2 or Test Panel 3 was laminated to the backside of the tape, subsequently forming a joint bond between the two test panels and tape sample. A 6 kg weight was applied to the bonded constructs for 15 seconds and the bonded article was allowed to dwell for 1 hour at 23° C. Next, a 483.9 mm² catch region of the tape strip, projecting out from the joint bond was pulled at 60° angle with respect to the bond plane, at a rate of 304.8 mm/min using a Sintech 500/S tensile testing machine (available from MTS, Eagan, Minn.). Samples that cleanly released from the bonded construct was recorded. For samples that did not stretch release and a bond remained, the height at which the samples broke or failed was recorded.

### Tensile Drop Test

Test Panel 1 was washed three times with isopropanol. Two strips of tape sample measuring 2 mm by 51 mm were applied lengthwise across the width of the underside cavity of a custom made aluminum test fixture having a weight of 143 grams such that they were 1.15 mm from the end walls of the cavity. The Test Panel 1 was centered within the cavity and in contact with the two strips of tape sample, subsequently bonding Test Panel 1 to the underside cavity of the custom aluminum test fixture. The bonded article was then positioned with the cavity facing upward and a 4 kg (8.8 lb) weight was placed on the exposed surface of Test Panel 1 for 15 seconds after which it was removed and the bonded article was allowed to dwell for 24 hours at 23° C. and 50% RH. The bonded article was then evaluated for drop resistance in a tensile mode using a drop tester (DT 202, available from Shinyei Corporation of America, New York, N.Y.) and a horizontal orientation of the bonded article with Test Panel 1 facing downward. The bonded article was dropped onto a 1.2 cm thick steel plate until failure starting at a height of 30 cm for 30 drops, then 70 cm for 30 additional drops, and finally 120 cm for 30 drops. Two samples were tested, the number of drops to failure was recorded for each, and the average number of drops to failure was reported. The method and drop assembly is described in U.S. Patent Appl. Pub. No. US2015/0030839.

### Preparation of Acrylic Copolymers

Acrylic copolymers were prepared having the compositions shown in Table 1. For the copolymers, the components in the amounts shown in Table 1 were mixed in amber bottles. Approximately 26 grams of the mixture were placed in a 18 cm×5 cm clear heat sealable poly(ethylene vinyl acetate) bag obtained under the trade designation VA-24 from Flint Hills Resources; Wichita, Kans. Air was forced out of the open end and the bag was sealed using an impulse heat sealer (Midwest Pacific Impulse Sealer; J.J. Elemer Corp.; St. Louis, Mo.). The sealed bags were immersed in a constant temperature water bath at 17° C. and irradiated with ultraviolet light (365 nm, 4 mW/cm²) for eight minutes on each side to produce the acrylic copolymer. The method of forming the packages and curing are described in Example 1 of U.S. Pat. No. 5,804,610, the subject matter of which is incorporated herein by reference in its entirety.

TABLE 1
Compositions of acrylic copolymers (in parts by weight)

| Polymer | EHA | AA | Irg651 | IOTG |
|---|---|---|---|---|
| AC1 | 94 | 6 | 0.15 | 0 |
| AC2 | 95 | 5 | 0.15 | 0.03 |

### Preparation of Samples

### Examples 1-20

Examples 1-20 were single layer tape constructions. For all samples, starting components were compounded using a 30 mm co-rotating twin screw extruder (available from Berstorff) having the formulations found in Table 2 and metered using a gear pump (available from Colfax). Samples were compounded according to the following procedure with an overall throughput of 4.54 kg/hr (10 lbs/hr). K1161 and Irg1010 were dry fed into the first zone of the 30 mm co-rotating twin screw extruder. Using a single screw extruder (available from Berstorff), AC1 was heated and fed into the third zone of the twin screw extruder. Tackifier resins, P100 or P125, were heated and fed into the fourth zone of the extruder using a gridmelter (available from Dynatec). The subsequent compounded melt stream was metered using a gear pump (available from Colfax), and was cast with a 150 micrometer (6 mil) thickness onto Release Liner 1 using a rotary-rod die (available from Nordson EDI). A second Release Liner 1 was laminated on the open-face side of the tape samples, resulting in tapes with liners on both sides. All of the tape samples were exposed to e-beam radiation on each side using an ELECTROCURTAIN CB-300 e-beam unit (Energy Sciences Incorporated, Wilmington, Mass.) at an accelerating voltage of 250 kiloelectron volts, and a dose of 5 megarads, per side.

TABLE 2
Hotmelt extrusion compounded compositions
for Examples 1-20, in weight %

| Example | K1161 | AC1 | P100 | P125 | Irg1010 |
|---|---|---|---|---|---|
| 1 | 47.00 | 47.00 | 5.00 | 0.00 | 1.00 |
| 2 | 44.50 | 44.50 | 10.00 | 0.00 | 1.00 |
| 3 | 42.00 | 42.00 | 15.00 | 0.00 | 1.00 |
| 4 | 39.50 | 39.50 | 20.00 | 0.00 | 1.00 |
| 5 | 37.00 | 37.00 | 25.00 | 0.00 | 1.00 |
| 6 | 59.33 | 29.67 | 10.00 | 0.00 | 1.00 |
| 7 | 56.00 | 28.00 | 15.00 | 0.00 | 1.00 |
| 8 | 52.67 | 26.33 | 20.00 | 0.00 | 1.00 |
| 9 | 49.33 | 24.67 | 25.00 | 0.00 | 1.00 |
| 10 | 66.75 | 22.25 | 10.00 | 0.00 | 1.00 |
| 11 | 63.00 | 21.00 | 15.00 | 0.00 | 1.00 |
| 12 | 59.25 | 19.75 | 20.00 | 0.00 | 1.00 |
| 13 | 55.50 | 18.50 | 25.00 | 0.00 | 1.00 |
| 14 | 44.50 | 44.50 | 0.00 | 10.00 | 1.00 |
| 15 | 42.00 | 42.00 | 0.00 | 15.00 | 1.00 |
| 16 | 39.50 | 39.50 | 0.00 | 20.00 | 1.00 |
| 17 | 56.00 | 28.00 | 0.00 | 15.00 | 1.00 |
| 18 | 52.67 | 26.33 | 0.00 | 20.00 | 1.00 |
| 19 | 63.00 | 21.00 | 0.00 | 15.00 | 1.00 |
| 20 | 59.25 | 19.75 | 0.00 | 20.00 | 1.00 |

### Examples 21-28

Examples 21-28 are single layer tape constructions with compositions displayed in Table 3. All samples were prepared using a batch hotmelt mixing and coating twin screw extruder (available from Davis-Standard). These formulations were hotmelt mixed for 3 minutes in a twin screw mixing zone at 320° F. and 250 RPM; extruded through a contact die (available from Cloeren); and finally coated with a with a 150 micrometer (6 mil) thickness on Release Liner 1. A second Release Liner 1 was laminated on the open-face side of the tape samples, resulting in tapes with liners on both sides. All of the samples were exposed to e-beam radiation on each side using an ELECTROCURTAIN CB-300 e-beam unit (Energy Sciences Incorporated, Wilmington, Mass.) at an accelerating voltage of 250 kiloelectron volts, and a dose of 5 megarads, per side.

TABLE 3
Hotmelt compounded compositions Examples 21-28, in weight %

| Example | K1161 | P100 | F85 | AC2 | Irg1010 |
|---|---|---|---|---|---|
| 21C | 0.00 | 0.00 | 0.00 | 99.00 | 1.00 |
| 22C | 0.00 | 10.00 | 0.00 | 89.00 | 1.00 |
| 23 | 44.50 | 10.00 | 0.00 | 44.50 | 1.00 |
| 24 | 66.75 | 10.00 | 0.00 | 22.25 | 1.00 |
| 25 | 22.25 | 10.00 | 0.00 | 66.75 | 1.00 |
| 26 | 66.75 | 0.00 | 10.00 | 22.25 | 1.00 |
| 27C | 89.00 | 10.00 | 0.00 | 0.00 | 1.00 |
| 28C | 79.00 | 20.00 | 0.00 | 0.00 | 1.00 |

### Examples 29-37

Examples 29-37 were multilayer samples having a three-layer ABA construction. For all samples, Melt stream Layer A was compounded using a 25 mm co-rotating twin screw extruder (available from Berstorff) having the compositions found in Table 4 and metered using a gear pump (available from Colfax). Melt stream Layer A was compounded according to the following procedure with throughputs shown in Table 5. One part per hundred Irg1010 was blended with K1161 and the mixture was then dry fed into the first zone of the 25 mm co-rotating twin screw extruder. Using a single screw extruder (available from Berstorff), AC1 was heated and fed into the third zone of the Layer A twin screw extruder. Tackifier resin or P100, were heated and fed into the fourth zone of the extruder for Layer A using a gridmelter (available from Dynatec). The compounded Melt Stream A leaving the twin screw extruder, was split evenly into two melt streams and metered using two gear pumps (available from Colfax). Melt stream Layer B was compounded using a 26 mm co-rotating twin screw extruder (available from Coperion) having the compositions found in Table 4. Melt stream Layer B was compounded according to the following procedure with throughputs shown in Table 5. One part per hundred Irg1010 was blended with K1161 and the mixture was then dry fed into the first zone of the 26 mm co-rotating twin screw extruder. Calsol or tackifier resin P100, were heated and fed into the fourth zone of the extruder using a gridmelter (available from Dynatec). The two Melt Stream A's and Melt Stream B were merged using a multi-manifold die (available from Cloeren) forming an ABA multilayer construction, and cast to thickness of 150 micrometers (6 mil) on Release Liner 1. A second Release Liner 1 was laminated on the open-face side of the multi-layer tape samples, resulting in tapes with liners on both sides. All of the samples were exposed to e-beam radiation on each side using an ELECTROCURTAIN CB-300 e-beam unit (Energy Sciences Incorporated, Wilmington, Mass.) at an accelerating voltage of 250 kiloelectron volts, and a dose of 5 megarads, per side.

TABLE 4
Hotmelt extrusion compounded compositions
for Examples 21-44, in weight %

| Composition | K1161 | AC1 | F85 | P100 | Calsol |
|---|---|---|---|---|---|
| Comp1 | 51.87 | 27.93 | | 20.20 | |
| (for layer A) | | | | | |
| Comp2 | 56.67 | 28.33 | | 15.00 | |
| (for layer A) | | | | | |
| Comp3 | 90.00 | | | | 10.00 |
| (for layer B) | | | | | |
| Comp4 | 95.00 | | | | 5.00 |
| (for layer B) | | | | | |
| Comp5 | 79.00 | | | 21.00 | |
| (for layer B) | | | | | |

TABLE 5
Multilayer tape samples for Examples 29-37

| | |
|---|---|
| Layer A | Layer B |

| Example | Material | kg/hr (lb/hr) | Material | kg/hr (lb/hr) |
|---|---|---|---|---|
| 29 | Comp1 | 9.07 (20) | Comp3 | 9.07 (20) |
| 30 | Comp1 | 9.07 (20) | Comp3 | 4.54 (10) |
| 31 | Comp1 | 9.07 (20) | Comp3 | 2.27 (5) |
| 32 | Comp1 | 9.07 (20) | Comp4 | 9.07 (20) |
| 33 | Comp1 | 9.07 (20) | Comp4 | 4.54 (10) |
| 34 | Comp1 | 9.07 (20) | Comp4 | 2.27 (5) |
| 35 | Comp2 | 9.07 (20) | Comp5 | 2.27 (5) |
| 36 | Comp2 | 9.07 (20) | Comp5 | 4.54 (10) |
| 37 | Comp2 | 9.07 (20) | Comp5 | 9.07 (20) |

### Results

For Examples 1-20 and Commercial Tape, stretch release testing was performed according to the Stretch Release Test using Test Panel 2 as the backside panel of the bonded joint, and the results are displayed in Table 6. Table 6 also reports the results of tensile drop testing.

TABLE 6
Stretch release and tensile drop measurements for Examples 1-20

| | Stretch Release | | Tensile Drop | | | |
|---|---|---|---|---|---|---|
| | Release | Failure | 30 cm | 70 cm | 120 cm | Total |
| Example | Yes/No | Height cm | # drops | # drops | # drops | # drops |
| 1 | Yes | | 30 | 8 | | 38 |
| 2 | No | 3.89 | 30 | 8 | | 38 |
| 3 | No | 1.73 | 30 | 5.5 | | 35.5 |
| 4 | No | 1.14 | 30 | 2 | | 32 |
| 5 | No | 1.14 | 30 | 3.5 | | 33.5 |
| 6 | Yes | | 30 | 15 | | 45 |
| 7 | No | 3.18 | 30 | 21.5 | | 51.5 |
| 8 | No | 2.03 | 28 | 6 | | 34 |
| 9 | No | 2.74 | 30 | 23 | 4 | 57 |
| 10 | Yes | | 30 | 9.5 | | 39.5 |
| 11 | Yes | | 30 | 19.5 | | 49.5 |
| 12 | No | 2.67 | 30 | 23.5 | 1 | 54.5 |
| 13 | No | 2.29 | 30 | 25 | 1 | 56 |
| 14 | Yes | | 30 | 2 | | 32 |
| 15 | No | 1.78 | 30 | 4.5 | | 34.5 |
| 16 | No | 1.98 | 30 | 3.5 | | 33.5 |
| 17 | No | 11.30 | 30 | 6 | | 36 |
| 18 | No | 2.29 | 30 | 7 | | 37 |
| 19 | No | 14.12 | 30 | 28 | | 58 |
| 20 | No | 3.00 | 30 | 17 | 2 | 49 |
| Commercial | Yes | | 17 | 2 | | 19 |
| Tape | | | | | | |

Examples 1-20 demonstrated that embodiments of the present disclosure provided significantly higher drop resistance, demonstrated by higher tensile drop results, compared to the commercially available stretch release tape. Further, embodiments of the present disclosure may maintain superior drop resistance while providing a stretch release performance equivalent to Commercial Tape.

For Examples 21C-22C, 23-26, and 27C-28C, stretch release testing was performed using Test Panel 3 as the backside panel of the bonded joint, and the results are displayed in Table 7. Table 7 also reports the results of tensile drop testing.

TABLE 7
Stretch release and tensile drop measurements for Examples 21-28

| | Stretch Release | | Tensile Drop | | | |
|---|---|---|---|---|---|---|
| Example | Release | Failure | 30 cm | 70 cm | 120 cm | Total |
| # | Yes/No | Height cm | # drops | # drops | # drops | # drops |
| 21C | No | 2.67 | 30 | 1 | | 31 |
| 22C | No | 1.65 | 30 | 1 | | 31 |
| 23 | Yes | | 30 | 13 | | 43 |
| 24 | Yes | | 30 | 13 | | 43 |
| 25 | No | 1.27 | 30 | 4 | | 34 |
| 26 | No | 15.62 | 30 | 1.5 | | 31.5 |
| 27C | — | — | — | — | — | — |
| 28C | — | — | — | — | — | — |

As with Examples 1-20, Examples 23-26 demonstrated that embodiments of the present disclosure provided significantly higher drop resistance, demonstrated by higher tensile drop results, compared to the commercially available stretch release tape. Further, embodiments of the present disclosure may maintain superior drop resistance while providing a stretch release performance equivalent to Commercial Tape. Example 26, which utilized a tackifier that is not incompatible with the polyacrylate, demonstrated less improvement.

Examples 21C and 22C were comparative as they contained no tackified styrenic block copolymer. These comparative examples demonstrated lower drop resistance, although still higher than the commercially available stretch release tape.

Examples 27C and 28C were comparative as they contained no acrylic polymer. Neither could be evaluated for stretch release or tensile drop because no bond could be formed. Examples 27C and 28C demonstrate that the tackified styrenic block copolymer used in exemplified embodiments of the present disclosure lacks tack and is not in itself a pressure sensitive adhesive.

For multi-layer Examples 29-37 and Commercial Tape, stretch release testing was performed according to the Stretch Release Test using Test Panel 3 as the backside panel of the bonded joint, and the results are displayed in Table 8. Tensile drop testing was performed according to the Tensile Drop Test on selected samples and are reported in Table 8.

TABLE 8
Stretch release and tensile drop measurements for Examples 29-37

| | Stretch Release | | Tensile Drop | | | |
|---|---|---|---|---|---|---|
| Example | Release | Failure | 30 cm | 70 cm | 120 cm | Total |
| # | Yes/No | Height cm | # drops | # drops | # drops | # drops |
| 29 | No | 74.3 | | | | |
| 30 | No | 44.19 | | | | |
| 31 | No | 53.72 | | | | |
| 32 | No | 80.77 | | | | |
| 33 | No | 41.91 | | | | |
| 34 | No | 6.858 | | | | |
| 35 | No | 41.02 | | | | |
| 36 | No | 31.75 | | | | |
| 37 | Yes | | 15.5 | 11 | | 26.5 |
| Commercial | Yes | | 17 | 2 | | 19 |
| Tape | | | | | | |

Examples 29-37 demonstrate that multi-layer samples with elastomer interlayer can also provide stretch release properties while providing enhanced drop performance compared to Commercial Tape. The ability to incorporate an additional layer within the tape constructions may enable additional improvements in tape properties, e.g., convertibility, chemical resistance, and the like.

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A stretch-release adhesive derived from a mixture comprising:
a) a tackified styrenic block copolymer comprising:
i) one or more tackifiers; and
ii) one or more styrenic block copolymers;
wherein the weight ratio of i) to ii) is not more than 1.0:2.0; and
b) one or more (meth)acrylate polymers.

2. The stretch-release adhesive according to claim 1 wherein the weight ratio of i) to ii) is not more than 1.0:4.0 and at least 1.0:10.0.

3. The stretch-release adhesive according to claim 1 wherein the tackified styrenic block copolymer is not tacky.

4. The stretch-release adhesive according to claim 1 wherein the weight ratio of a) to b) is between 0.4:1.0 and 5.0:1.0.

5. The stretch-release adhesive according to claim 1 wherein the weight ratio of a) to b) is at least 1.0:1.0 and not more than 3.9:1.0.

6. The stretch-release adhesive according to claim 1 wherein the one or more styrenic block copolymers comprise less than 18 wt % styrenic content.

7. The stretch-release adhesive according to claim 1 wherein the one or more styrenic block copolymers comprise at least 90 wt % linear block copolymers.

8. The stretch-release adhesive according to claim 1 wherein the one or more styrenic block copolymers comprise at least 55 wt % styrenic block copolymers comprising a rubbery block comprising unsaturated bonds.

9. The stretch-release adhesive according to claim 1 wherein the one or more tackifiers have solubility parameters of less than 8.9 (cal/cm²)^{1/2}.

10. The stretch-release adhesive according to claim 1 wherein the one or more styrenic block copolymers comprise styrenic blocks and rubbery blocks and the one or more tackifiers are miscible with the rubbery blocks, and wherein the one or more tackifiers are not miscible with the one or more (meth)acrylate polymers.

11. The stretch-release adhesive according to claim 1 wherein the one or more tackifiers are alicyclic saturated hydrocarbon resins.

12. The stretch-release adhesive according to claim 1 wherein the one or more (meth)acrylate polymers include at least 1 wt % highly polar monomeric units and
not more than 15 wt % highly polar monomeric units.

13. The stretch-release adhesive according to claim 1 wherein the one or more (meth)acrylate polymers have solubility parameters of greater than 9.1 (cal/cm²)^{1/2}.

14. The stretch-release adhesive according to claim 1 wherein the mixture is crosslinked.

15. The stretch-release adhesive according to claim 14 wherein the mixture is crosslinked by e-beam radiation.

16. A tape comprising the stretch-release adhesive according to claim 1.
